(19) United States
(12) Patent Application Publication
(10) Pub. No.: US 2015/0127891 A1
(43) Pub. Date: May 7, 2015

(54) WRITE PERFORMANCE PRESERVATION WITH SNAPSHOTS

(71) Applicant: FALCONSTOR, INC., MELVILLE, NY (US)

(72) Inventor: Henglin YANG, Florham Park, NJ (US)

(73) Assignee: FALCONSTOR, INC.

(21) Appl. No.: 14/532,759

(22) Filed: Nov. 4, 2014

Related U.S. Application Data
(60) Provisional application No. 61/899,703, filed on Nov. 4, 2013.

(51) Int. Cl. G06F 3/06

(52) U.S. Cl. CPC G06F 3/0619; G06F 3/0679; G06F 3/065; G06F 3/067; G06F 2206/1014
USPC 711/103; 711/162

(57) ABSTRACT

Storage systems and methods for performing write commands and preserving data. A write is received to a first logical page in first memory. The first logical page corresponds to a first physical page. The write command is redirected to a second physical page different from the first physical page. Data is written to the new physical page in response to the write request. After writing the data to the new physical page, the data is copied from the first physical page to second memory. The write operation is not, therefore, delayed while data is copied for preservation. The first memory may comprise NAND based flash memory, for example, such as an SSD.

### RELATED APPLICATION

The present application claims the benefit of U.S. Provisional Patent Application No. 61/899,703, which was filed on Nov. 4, 2013 is assigned to the assignee of the present invention, and is incorporated by reference herein.

### FIELD OF THE INVENTION

Storage systems and methods, and more particularly, storage systems and methods that preserve write performance by asynchronously copying data for preservation after performing a write operation.

### BACKGROUND

A NAND flash memory is typically organized in blocks. Each block contains a certain number of writable pages, such as 64 writable pages, for example. A page is typically 4096 bytes in size. An individual bit can only be programmed to change from one to zero, while only a block can be erased, resetting all the bits in the block to one. A write operation normally covers a page. Once a page is written, it is highly unlikely to modify that page to change the data to the content of another write operation.

A NAND flash based technology, such as a solid state disk or other solid state device (“SSD”), handles a write operation differently than a hard drive disk. An SSD redirects a page write to a logical block addressing (“LBA”) system to another erased page and modifies an internal mapping of the LBA to the new page. The old page is put aside to be reclaimed by garbage collection. Before the old page is reclaimed by garbage collection, there are two copies of data for the same page at the LBA.

When a write to a page does not contain enough data to overwrite a whole page, a read operation is needed to retrieve from the existing page the part or parts of data not being overwritten. For example, if the first 3 KB of a 4 KB page is written, the last 1 KB of the existing page is read. The incoming 3 KB and the read 1 KB together are written to a new page. Internal mapping of the LBA to the existing page is modified to point to the new page.

Creating point-in-time copies of data, referred to as snapshots, is a commonly used technique for protecting data stored in a storage server. After a snapshot is created, modification of the protected data does not take place until the original data to be modified is stored.

Several algorithms may be used to preserve modified data. One algorithm is copy on first write (“COFW”). Whenever COFW happens, one write incurs four operations: 1) one operation to read old data; 2) one operation to write the old data (take a snapshot); 3) one operation to write metadata; and 4) one operation to write the new data. Another algorithm is copy on write (“COW”). COW performs the four operations of COFW for every write operation. In both cases, the new data is not written until the snapshot is performed. Since multiple operations are associated with a single write operation when using snapshots, performance is degraded (slowed).

### SUMMARY OF INVENTION

Embodiments of the invention preserve the write performance in NAND flash based memory devices, such as SSDs, and other types of memory devices or procedures where old data and new data coexist for a period of time after a write operation, by taking a snapshot of the old data after the write is performed, in a procedure separate from the write operation. Write performance is preserved because the write is not delayed by the taking of a snapshot.

In accordance with an embodiment of the invention, a write operation is not delayed by the preservation of old data. The write is performed and the old data is preserved until that data is copied. Three operations of the COW and COFW processes: 1) read old data; 2) write old data; and 3) write metadata, are therefore removed from the write operation path, to a separate asynchronous copy operation.

In accordance with one embodiment of the invention, a method for performing a write operation to a first physical page containing first data is disclosed comprising receiving a write command to the first logical page in first memory, the first logical page corresponding to a first physical page, by a processing device. The write command is redirected to a second physical page different from the first physical page and data is written to the new physical page in response to the write request. After writing the data to the new physical page, the data from the first physical page is copied to second memory. The second physical page may be correlated with the first physical page. The first memory may comprise NAND based flash memory, such as a solid state device (SSD).

In accordance with another embodiment of the invention, as system is disclosed comprising first and second memory. At least one processing device is provided, configured to receive a write request to write data to a first physical page in the first memory. A second physical page different from the first physical page is picked up by the at least one processing device. The second data is written to the second page and then the first data is stored in the second memory. After writing the data to the new physical page, the data from the first physical page is copied to second memory. The second physical page may be correlated with the first physical page. The first memory may comprise NAND based flash memory, such as a solid state device (SSD). The first memory may be in a primary resource and the second memory may be in a snapshot resource, for example.

In the following discussion, data stored in “resources” refers to collections of data stored in a storage system.

### BRIEF DESCRIPTION OF THE DRAWINGS

FIG. 1 is a block diagram of a storage system for performing write operations, in accordance with an embodiment of the invention;

FIG. 2 is a schematic diagram of an example of a primary resource used in the embodiment of FIG. 1, including a mapping table and a change table, in accordance with an embodiment of the invention;

FIGS. 3-5 are examples of the operation of the mapping table and the change table of FIG. 2, after multiple write operations;

FIG. 6 is a flowchart 600 of an example of the operation of the primary resource of FIG. 1 during a write operation, in accordance with an embodiment of the invention;

FIG. 7 is a flowchart of an example of the operation of the storage controller of FIG. 1 when a physical page is replaced, in accordance with another embodiment of the invention; and

FIG. 8 is an example of the operation of the storage controller during a copy operation, in accordance with an embodiment of the invention.

### DETAILED DESCRIPTION

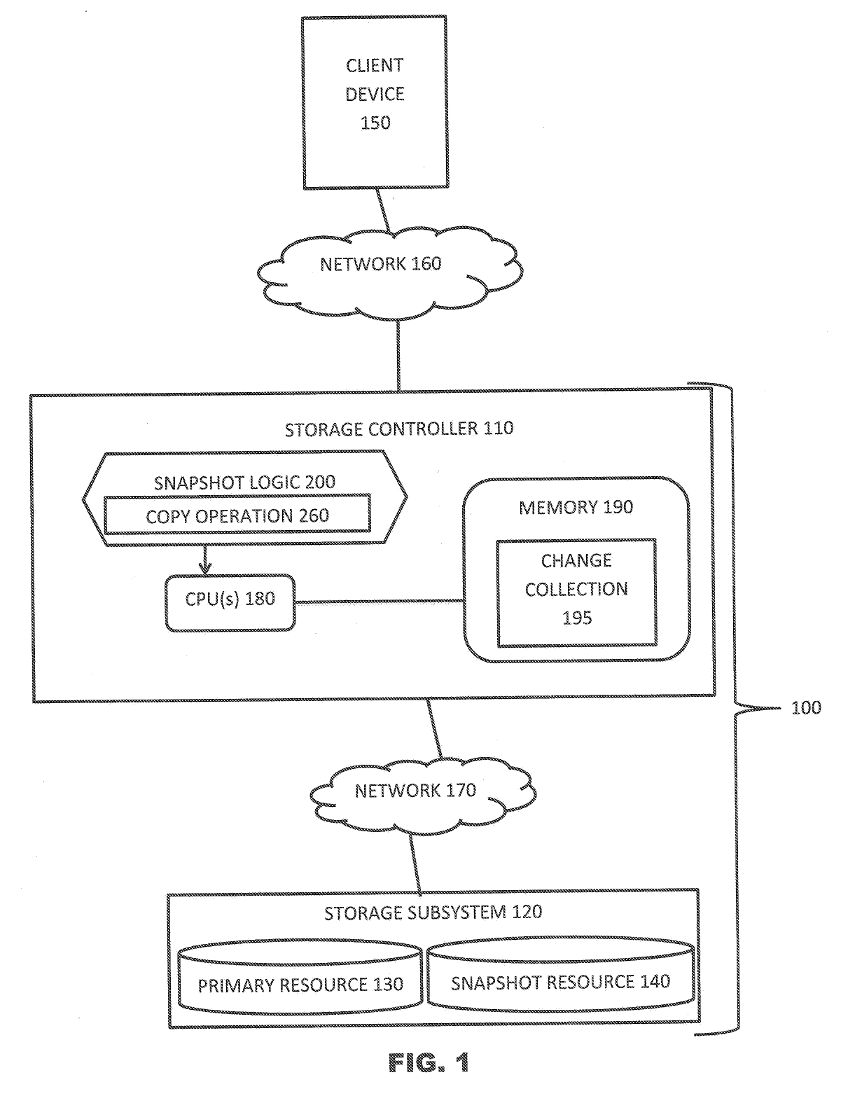

FIG. 1 is a block diagram of a storage system 100 for performing write operations in accordance with embodiment of the invention. The system 100 includes storage controller 110 and a storage subsystem 120. A client device 150 accesses the storage controller 110 through a first network 160. The storage controller 110 is coupled to the storage subsystem 110 through a second network 170.

The storage controller 110 comprises one or more processing devices, such as servers comprising central processing units (“CPU(s)”) 180. The storage controller 110 also comprises memory 190. In this example, the memory 190 defines a change collection map 195, which keeps track of changes in the correspondence between logical page numbers and physical page numbers for the storage controller 110. The change collection map is stored in volatile memory, such as random access memory, in this example. Snapshot logic software 200, which is also stored in the memory 190 or another such memory, controls in part, the operation of the CPU 180 with respect to conducting snapshots of old data.

The storage subsystem 120 comprises a primary resource 130 and a snapshot resource 140. The primary resource 130 comprises the logical partition of storage units in the storage subsystem 120. The primary resource 130 comprises a NAND flash based memory, such as an SSD. As discussed above, in a NAND based flash memory, one copy of old data and one copy of new data exist immediately after a write operation, without performance degradation.

The snapshot resource 140 contains point-of-time copies or snapshots of data. The snapshot resource 140 in the storage subsystem 120 may be any type of memory drive, such as a NAND based flash memory. The primary resource 130 and snapshot resource 130 may use the same NAND based flash memory, for example. The snapshot resource 140 is not exposed to a client device 150. The snapshot resource operates transparently, so that the client device 150 sees only the primary resource 130. The primary resource 130 may be a snapshot enabled primary resource comprising a snapshot resource and a primary resource.

While only one storage controller 110 and one storage subsystem 120 are shown in FIG. 1, the storage system 100 may comprise multiple storage controllers 110 and/or storage subsystems 120. Some primary resources 130 may have corresponding snapshot resources 140. Other primary resources without snapshot capabilities may not have a corresponding snapshot resource. The storage system 100 may also provide storage for multiple clients 150. When multiple primary resources 130 with snapshot capabilities are provided, each primary resource may have a corresponding change collection table in the memory 190 of the storage controller 110.

The networks 160, 170 may be of any type, such as PCIe, Fibre Channel, SATA, PATA, SCSI, and/or iSCSI, for example. The networks 160, 170 may each be the same network, separate networks of the same type, or separate networks of different types, for example.

In accordance with an embodiment of the invention, a write operation does not wait for the preservation of old data. When a write to a logical page comes into the primary resource 120 from a client 150 via the storage controller 110, the write is redirected to a new physical page, and the new data is written to the new physical page. The write is performed without having to wait for copying or taking a snapshot of the old data. The old data is preserved in the primary resource 112 until that data is copied by the storage controller 110. Three of the operations of the COW and COFW processes: 1) read old data; 2) write old data; and 3) write metadata, are therefore removed from the write operation path, to a separate asynchronous copy operation performed by the storage controller 130. The CPU 180 of the storage controller 130 may perform the separate copy operation under the control of the copy operation software 260, which may be part of the snapshot logic software 200, for example.

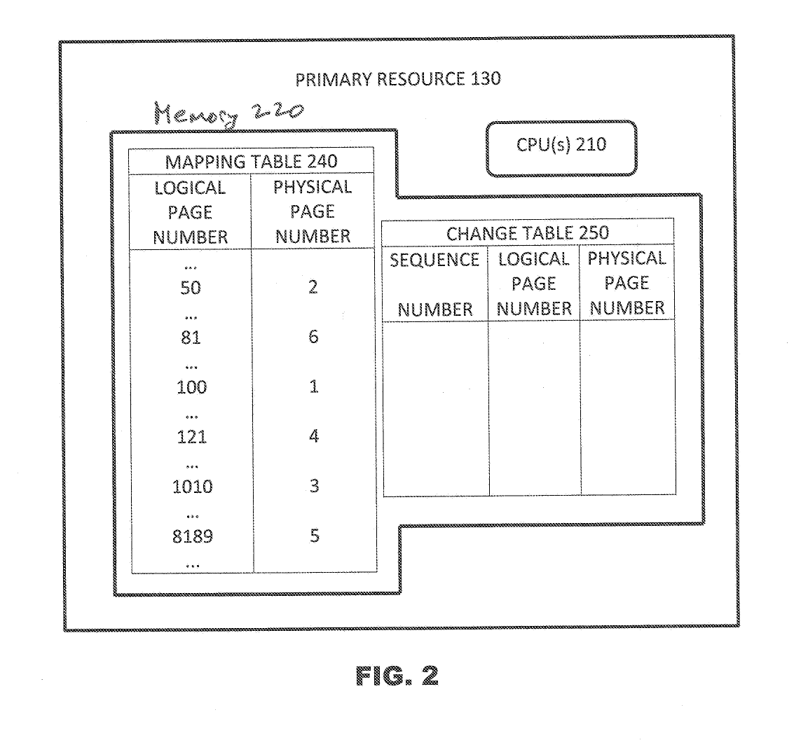

FIG. 2 is a schematic diagram of an example of a primary resource 130 used in the embodiment of FIG. 1. The primary resource 130 comprises one or more processing devices, such as CPUs 210, and memory 220. The memory 220 in this example comprises non-volatile memory defining a mapping table 240 and a change table 250. The mapping table 240 associates current logical page numbers with current physical page numbers, respectively, of the logical partition of the primary resource 130. The change table 250 keeps track of prior changes made in the mapping table 240, by associating logical pages with physical pages prior to a write to a respective page and before a snapshot. A physical page number may comprise one or more pieces of information. For example, in NAND flash based SSD there can be two pieces of information, one for the block and the other for the page number within the block.

FIG. 2 shows the mapping table 240 and the change table 250 before the primary resource 112 is instructed to start keeping track of replaced physical pages. The mapping table 240 contains the current logical mapping of logical page numbers to physical page numbers and the change table 250 is empty. When a snapshot is created, the CPU 210 of the primary resource 130 starts to keep track of replaced physical pages. The mapping table 240 is updated by the primary resource 130 to reflect the new association of the new physical page and the logical page and to complete the write operation.

In this example, after the new data is written to the new physical page, the old physical page number and logical page number are assigned a sequence number indicating the number of the write request. Write requests may be numbered consecutively as they are received by the primary resource 112.

The sequence number, the logical page number, and the old physical page number are then saved into the change table 250 by the CPU 210 of the primary resource 220. The change table 250 acts as a working table to keep track of logical page numbers and corresponding physical page numbers prior to taking a snapshot of the old data. The logical page number and the sequence number may be passed to the controller 110 by the primary resource 130 at an appropriate time after performing the write and copying the old data to the snapshot resource 140, via the network 160. Alternatively, the controller 110 may retrieve the data from the change table 250. At this time, the old physical page is still in use and garbage collection or other such cleaning operation does not reclaim the old physical page for reuse.

In one example, during the copy of the old data to the snapshot resource 140, the storage controller 110, asynchronously from the write operation: 1) takes off one entry from the change collection map 195 and reads old data by the sequence number of the entry in the change map from the primary resource 130; 2) writes the old data to the snapshot resource 140; and 3) writes the metadata for the old data to the snapshot resource. The storage controller 110 then instructs the primary resource 130 to remove an entry with the sequence number from change table 250. These operations may be performed by the storage controller 110 immediately after the write operation or later, such as several seconds later, for example. The speed of the write operation is thereby increased and may be comparable to the speed of a write operation when a snapshot is not taken.

When all snapshots are destroyed or there is no snapshot created for the primary resource 130, the primary resource is instructed by the storage controller 110, under the control of the snapshot logic software 200, to stop keeping track of replaced physical pages, via the network 170. The storage controller 110 also instructs the primary resource 130 to clear the entries from the change table 250 so that it is empty, under the control of the snapshot logic software 200, via the network 170.

When a primary resource 130 is not keeping track of replaced physical pages, replaced pages are marked for reclamation. The pages may be reclaimed by the CPU(s) 210 through garbage collection or another mechanism.

In FIG. 2, logical page numbers 50, 81, 100, 121, 1010, and 8189 are mapped to physical page numbers 2, 6, 1, 4, 3, and 5, respectively. The change table 250 is empty.

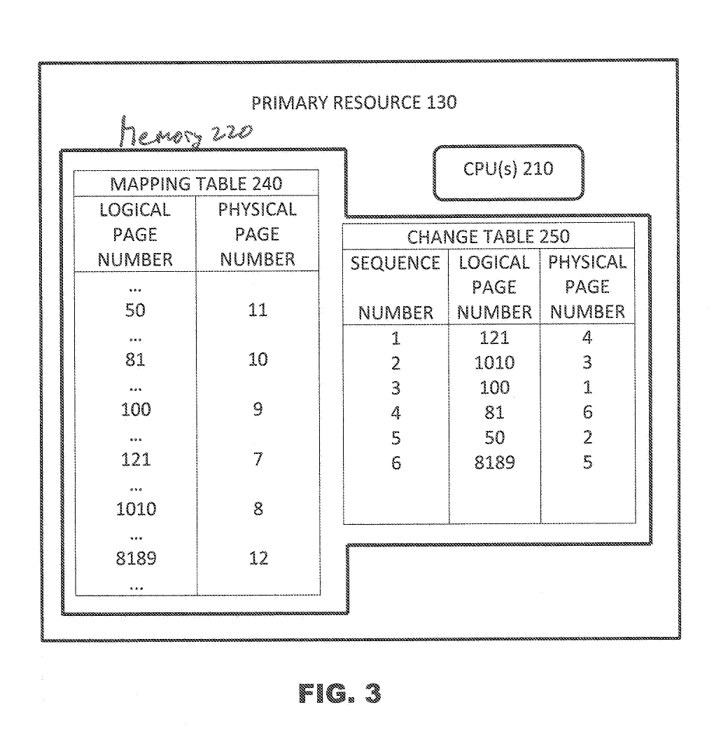

FIG. 3 shows the mapping table 240 and the change table 250 after processing of writes to the logical page numbers 121, 1010, 100, 81, 50, and 8189, in that order. Each write is assigned a sequence number 1-6 respectively, in the order of the write. In particular, Sequence No. 1 in the change table 250 is assigned to the first write to logical page number 121, which corresponds to physical page number 4 in FIG. 2. Sequence No. 2 in the change table 250 is assigned to the second write operation to logical page number 1010, which corresponded to physical page number 3 in FIG. 2. The same is true for Sequence Nos. 3-6, which correspond to logical page numbers 100, 81, 50, and 8189, respectively.

After the writes in this example, in Sequence No. 1, the physical page number corresponding to the logical page number 121 (previously page 4 in FIG. 2) is changed to 7. The physical page number corresponding to the logical page number 1010 (previously page 3 in FIG. 2) is changed to page 8. The physical page number corresponding to logical page number 100 in FIG. 2 (page 1) is changed to page 9. The physical page number corresponding to logical page number 81 (page 6 in FIG. 2) is changed to 10. The physical page number corresponding to logical page number 50 (page 2 in FIG. 2) is changed to 11. The physical page number corresponding to logical page number 8189 (page 2 in FIG. 2) is changed to 12.

When the storage controller 110 receives (or retrieves) the replaced physical page information from the primary resource 130, the storage controller adds the logical page number and the sequence number to a change collection map 195 in the memory 190. If the logical page number already exists, the storage controller 130 instructs the primary resource 130 to remove the entry with the sequence number from the change table 250.

The change collection map 195 may be organized in the memory 190 in different ways. For example, the change collection table 195 may be in the form of a binary search tree sorted by logical page number, or it may be a hashing table sorted by hash of the logical page number.

When the primary resource 112 receives removal instructions from the storage controller 110 for a sequence number, an entry with the sequence number is identified and removed from the change table 250 by the CPU 210 of the primary resource 130. The corresponding physical page is then marked for reclamation.

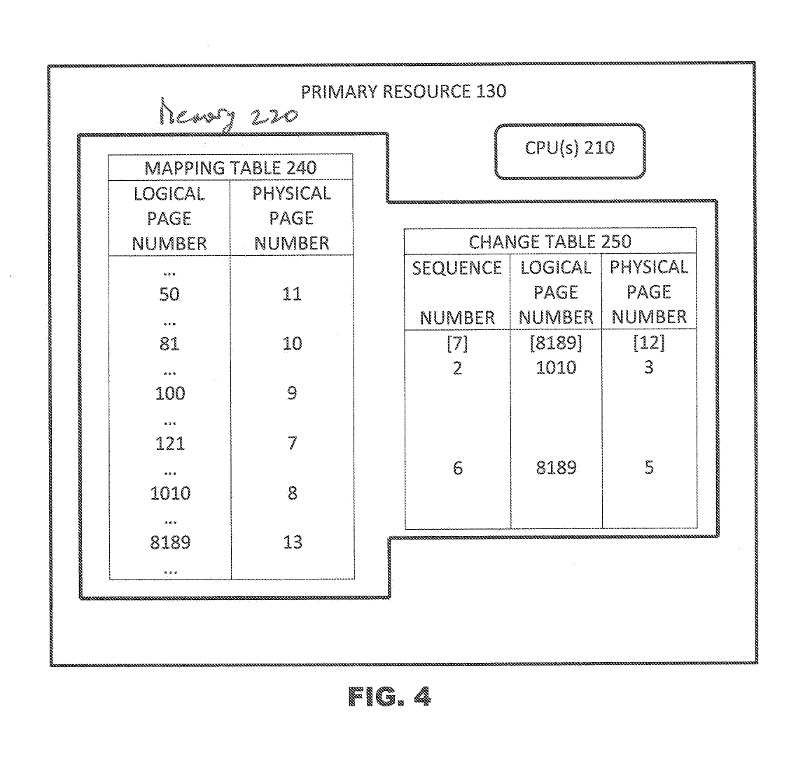

FIG. 4 shows the mapping table 220 and the change table 250 after logical pages 50 (Sequence No. 5), 81 (Sequence No. 4), 100 (Sequence No. 3), and 121 (Sequence No. 1) were copied by the storage controller 110 for storage as a snapshot in the snapshot resource 140, in accordance with embodiments of the invention. Another entry with Sequence No. 7 is present indicating that another write to logical page number 8189 was processed while the copy operation performed by the storage controller 110 was copying logical pages 50, 81, 100, and 121. The entry with Sequence No. 7 is in brackets because the entry will exist for only a brief moment, because it is not a first write to the logical page. Since in this example only first writes to a logical page require copying of the data to the snapshot resource 140, once an entry is determined not to be a first write, it is deleted.

In FIG. 4, sequences Nos. 3, 4, and 5, identified in the change table 250 in FIG. 3, have already been removed from the change table 250 in FIG. 4 by the primary resource 130, as instructed by the storage controller 110.

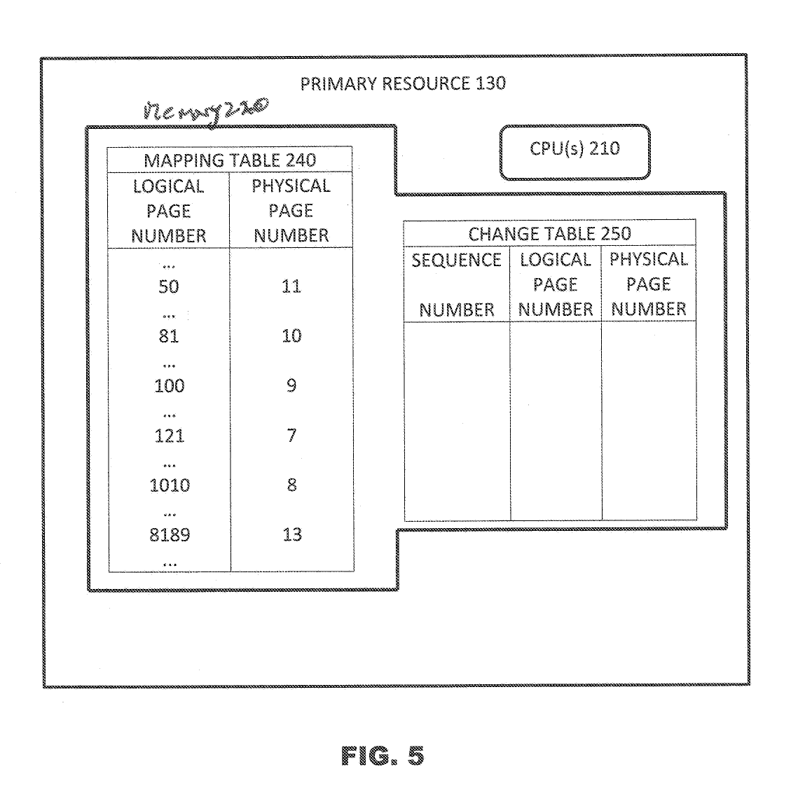

FIG. 5 shows the mapping table 240 and the change table 250 after logical pages 1010, 7124, and 8189, which had not yet been copied in FIG. 4, were copied by the storage controller 130 for storage in the snapshot resource 140 as snapshots, and all sequences have been cleared from the table.

The change collection map 195 in the volatile memory 190, is created by the CPU 180 in the storage controller 110. Since the memory 190 is volatile, the change collection map 195 would be lost if there were to be a power failure. After power comes back, a recovery operation may be performed by the CPU 180 under the control of the snapshot logic 200 to retrieve information from the non-volatile change table 250 in the primary resource 130. The snapshot logic 200 then rebuilds the change collection map 195 into the memory 190. The storage system 100 is then ready to operate again.

In another implementation of the copy operation, data is read from multiple physical pages of the primary resource 130, old data is saved in one write, and multiple metadata is updated in another write by the storage controller 110.

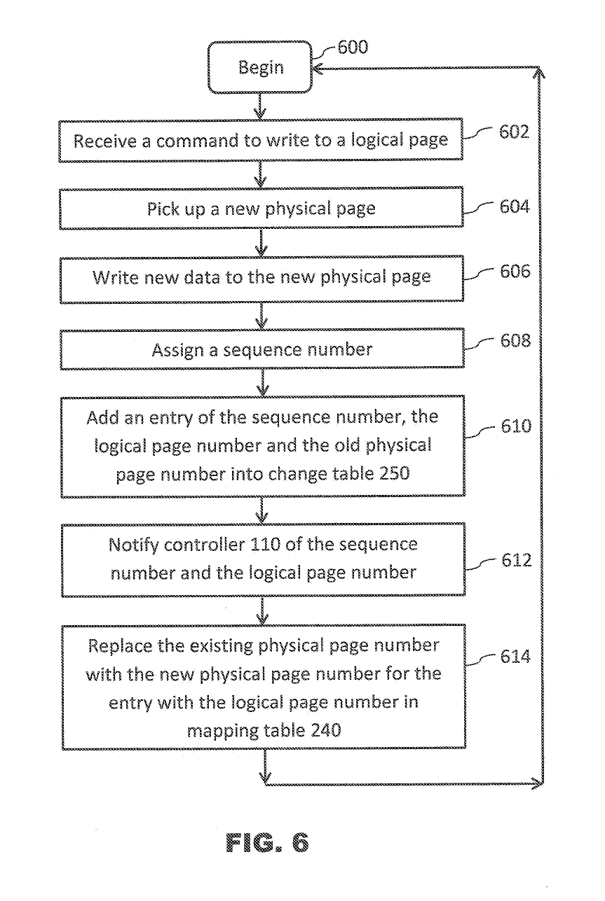

FIG. 6 is a flowchart 600 of an example of the operation of the primary resource 130 of FIG. 1, in accordance with an embodiment of the invention. A command to write to a logical page in a NAND flash based memory, such as an SSD, is received by the storage controller 110 from a client 150, via the network 160, in Step 602. The storage controller 110 passes the command to the primary resource 130 in the storage subsystem 120, via the network 170.

A new physical page is picked up by the primary resource 130, under the control of the CPU 210, in Step 604.

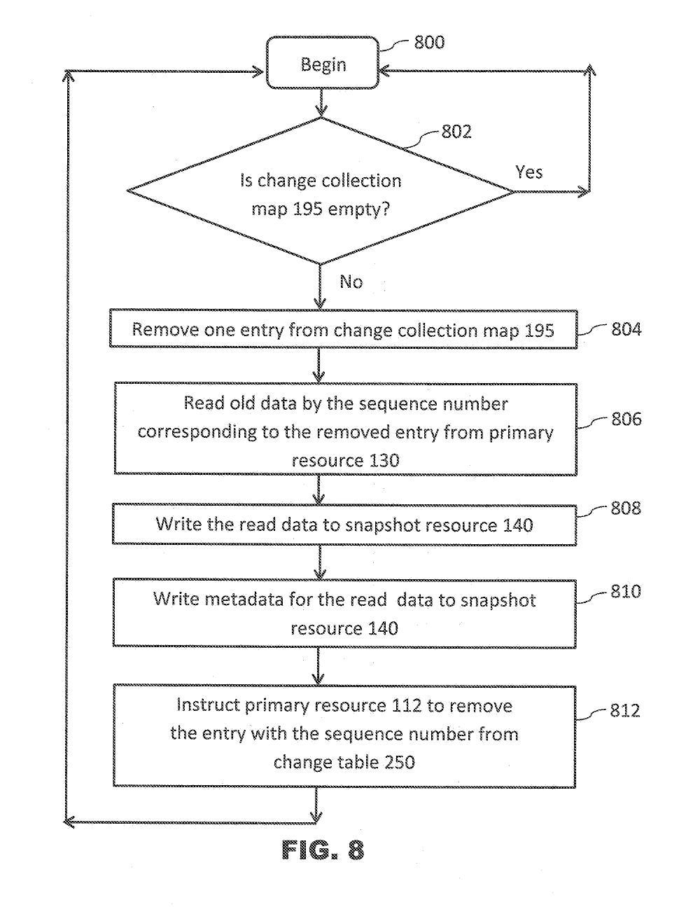

The new data is written to the new physical page, by the CPU 210, in Step 606. In contrast to known prior art COW and COFW techniques, the new data is written prior to and separate from the copying of the old data from the old physical page, which is described in FIG. 8, for example.

After the new data is written to the new physical page in Step 606, the old physical page number and corresponding logical page number are assigned a Sequence Number indicating the number of the write request, by the CPU 210, in Step 608. Write requests may be numbered consecutively as they are received by the primary resource 130.

The Sequence Number assigned in Step 608, the logical page number of the old physical page, and the old physical page number are saved in the change table 250, in Step 610.

The controller 110 is informed of the sequence number and the logical page number by the primary resource 240 in this example, in Step 612.

The old physical page number corresponding to the logical page number in the mapping table 240 is replaced by the new physical number with the newly written data, in Step 614.

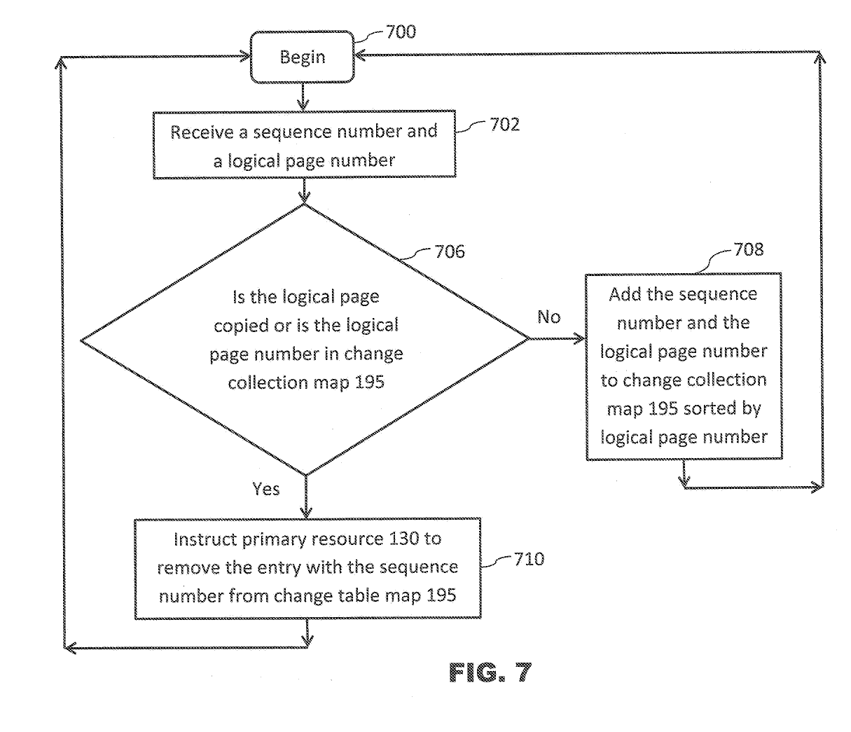

FIG. 7 is a flow chart 700 of an example of the operations of the storage controller 110 when it receives information about a replaced physical page passed by a primary resource 130 in a snapshot implementation with COFW.

The storage controller 110 receives the sequence number and the logical page number from the primary resource 130 (sent by the primary resource in Step 612 in FIG. 6), in Step 702, via the network 170.

When the storage controller 110 receives the replaced physical page information (logical page number and sequence number) from the primary resource 130 in Step 702, the storage controller 110 checks at Step 706 whether the logical page number already exists in the change collection map 195 or whether the logical page has already been copied (in which case it is not a first write to be copied in COFW). If the result from Step 706 is “No”, the storage controller 110 at Step 708 adds the logical page number and the sequence number to the change collection map 195, sorted by logical page number. Otherwise, if the check result is “Yes” at Step 706, the storage controller 110 instructs the primary resource 130 to remove the entry with the sequence number from the change table 250, in Step 710.

If the data preservation procedure is COW then Step 706 in FIG. 7 is not included and the process of FIG. 7 goes directly from Step 702 to Step 708. In COW, the collection map is also sorted by sequence number.

FIG. 8 is a flowchart 800 of an example of the asynchronous copy operation of a storage controller 110 separate from the write operation in FIG. 7, in accordance with embodiments of the invention. It is determined by the storage controller 110 whether the change collection map 195 is empty, in Step 802. If Yes, the storage controller 110 keeps checking until the change collection map 195 is not empty. When the change collection map 195 is not empty, the storage controller 110 instructs the primary resource 130 to remove the corresponding entry in the change table 250 having the sequence number from the change table 250, in Step 804.

Old data in the old physical pages is read by the storage controller 110, in Step 806. The read data is written to the snapshot resource 140 by the storage controller 110, in Step 808. Metadata for the written data is also written to the snapshot resource 140 by the storage controller, in Step 810. The primary resource 130 is then instructed by the storage controller 110 to remove the entry having that sequence number from the change table, in Step 812.

It will be appreciated by those skilled in the art that changes may be made to the embodiments described herein, without departing from the spirit and scope of the invention, which is defined by the following claims.

I claim:

1. A method for performing a write operation to a first physical page containing first data, comprising:
receiving a write command to the first logical page in first memory, the first logical page corresponding to a first physical page, by a processing device;
redirecting the write command to a second physical page different from the first physical page;
writing data to the new physical page in response to the write request; and
after writing the data to the new physical page, copying the data from the first physical page to second memory.

2. The method of claim 1, further comprising correlating the second physical page to the first with logical page.

3. The method of claim 1, wherein copying the data from the first physical page to second memory comprises:
taking a snapshot of the old data; and
storing the snapshot in the second memory.

4. The method of claim 1, wherein the first memory comprises NAND based flash memory.

5. The method of claim 3, wherein the NAND based flash memory comprises a solid state device, the method comprising:
writing the new data to a new physical page in the solid state device.

6. The method of claim 1, further comprising:
writing metadata for the old data to the second memory.

7. A system for storing and writing data, comprising:
first and second memory; and
at least one processing configured to:
receive a write request to write data to a first physical page in the first memory;
pick up a second physical page different from the first physical page;
write the second data to the second physical page;
read the first data after writing the second data to the second page; and
store the first data in the second memory.

8. The system of claim 7, wherein the first memory comprises NAND based flash memory.

9. The system of claim 8, wherein the NAND based flash memory comprises a solid state device.

10. The system of claim 7, wherein the at least one processing device is further configured to:
correlate the second physical page with the first logical page.

11. The system of claim 7, wherein the at least one processing device comprises at least one first processing device and at least one second processing device, the system further comprising:
a storage controller comprising the at least one first processing device, the storage controller configured to receive commands from a client device, via a network; and
a storage subsystem coupled to the storage controller via a network, the storage comprising:
a primary resource comprising the at least one second processing device and the first memory; and
a snapshot resource comprising the second memory;
wherein the at least one first processing device is configured to:
provide the write command to the primary resource; and
the at least one second processing device is configured to:
access a second physical page different from the first physical page in the first memory;
write the second data to the second physical page;
read the first data after writing the second data to the second page; and
store the first data in the snapshot resource.
